(19) United States
(12) Patent Application Publication
(10) Pub. No.: US 2025/0314923 A1
(43) Pub. Date: Oct. 9, 2025

(54) ACRYLATE BASED MATRIX LIQUID CRYSTALS NCAP

(71) Applicant: Orbotech Ltd., Yavne (IL)

(72) Inventors: Yaron Aviv, Modiin (IL); Shirly Kachlon, Mazkeret Batya (IL); Efraim Dvash, Hulda (IL); Omri Aviram Zur, Tel Aviv (IL); Ofir Yeari, Mishmar HaShiv'a (IL); Arye Schwarzbaum, Karnei Shomron (IL); Alan Lawrence Gershon, Hod HaSharon (IL); Maxim Khabad, Beer Sheva (IL)

(21) Appl. No.: 18/630,372

(22) Filed: Apr. 9, 2024

(51) Int. Cl. G02F 1/1333; G02F 1/1335; G02F 1/1343

(52) U.S. Cl. CPC G02F 1/133365; G02F 1/133553; G02F 1/13439

(57) ABSTRACT

An electro-optic modulator includes a modulator material layer. The modulator material layer includes a polymer matrix. Droplets of liquid crystals are dispersed within the polymer matrix. The liquid crystals are configured to modulate light transmissivity through the electro-optic modulator. The polymer matrix may include an acrylate-based matrix. The polymer matrix may reduce a turn-on voltage of the electro-optic modulator. The electro-optic modulator may be a component of an imaging system, also referred to as an automated optical inspection (AOI) system, a voltage imaging optical system (VIOS), an array checker, and the like. By reducing the turn-on voltage, process improvements of the optical inspection may be improved.

### TECHNICAL FIELD

The present disclosure generally relates to electro-optics, and more particularly to liquid crystal materials for use in electro-optic applications.

### BACKGROUND

Electro-optic modulators using liquid crystals, particularly nematic curvilinear aligned phases (NCAP) films, for modulation are used to test conduction of thin-film transistors and interconnects of flat panel displays (FPD) under fabrication. The electro-optic modulators are fabricated mechanically with thick, stacked subcomponents of glues, NCAP film on Mylar®, pellicle dielectric mirror, and hard coat using mechanical processes. Previous formulations of the electro-optic modulators include issues with droplet size, uniformity of droplets, and droplet dispersion. Therefore, it would be advantageous to provide a device, system, and method that cures the shortcomings described above.

### SUMMARY

A modulator material layer is described, in accordance with one or more embodiments of the present disclosure. The modulator material layer may include: a polymer matrix, wherein the polymer matrix includes a co-polymer which is polymerized from a first monomer, a second monomer, and a cross-linker; and a plurality of liquid crystal droplets dispersed within the polymer matrix.

In some aspects, the plurality of liquid crystal droplets range in size from 0.01 to 10 micrometers, wherein the plurality of liquid crystal droplets include an average size from 0.1 to 1.5 micrometers.

In some aspects, the plurality of liquid crystal droplets include the average size from 0.3 to 1 micrometers.

In some aspects, the plurality of liquid crystal droplets are from 50 wt. % to 80 wt. % of the modulator material layer.

In some aspects, the plurality of liquid crystal droplets are from 60 wt. % to 75 wt. % of the modulator material layer.

In some aspects, the first monomer includes a (meth)acrylate group and R2 bonded to the (meth)acrylate group, wherein R2 includes at least one of an alkane end group or a cycloalkane end group, wherein R2 does not include a conjugated system end group.

In some aspects, the first monomer includes at least one of lauryl acrylate or isobornyl acrylate.

In some aspects, the first monomer is from 5 wt. % to 13 wt. % of the modulator material layer.

In some aspects, the first monomer is from 6 wt. % to 10 wt. % of the modulator material layer.

In some aspects, the second monomer includes a (meth)acrylate group and R2′ bonded to the (meth)acrylate group, wherein R2′ includes a conjugated system end group.

In some aspects, the conjugated system end group includes an aryl group.

In some aspects, the aryl group includes at least one of a phenyl group or a naphthyl group.

In some aspects, the second monomer includes at least one of ethylene glycol phenyl ether acrylate, 2-Naphthyl acrylate, or Pentafluorophenyl acrylate.

In some aspects, the second monomer is from 7 wt. % to 15 wt. % of the modulator material layer.

In some aspects, the second monomer is from 13 wt. % to 15 wt. % of the modulator material layer.

In some aspects, the cross-linker is a multi-(meth)acrylate monomer with two, three, or four (meth)acrylate groups.

In some aspects, the cross-linker includes at least one of 1,6-Hexanediol diacrylate, 1,4-Phenylene dimethacrylate, Bisphenol A dimethacrylate, 1,4-Bis[4-(3-acryloyloxypropoxy)benzoyloxy]-2-methylbenzene, or 2-Methyl-1,4-phenylene Bis[4-[[[4-(acryloyloxy)-butoxy]carbonyl]oxy]benzoate].

In some aspects, the cross-linker is from 1 wt. % to 10 wt. % of the modulator material layer.

In some aspects, the cross-linker is from 6 wt. % to 8 wt. % of the modulator material layer.

In some aspects, the first monomer is lauryl acrylate, wherein the second monomer is ethylene glycol phenyl ether acrylate, wherein the cross-linker is 1,6-Hexanediol diacrylate.

In some aspects, the polymer matrix includes a photo-initiator, wherein the photo-initiator is from 0 wt. % to 3 wt. % of the modulator material layer.

In some aspects, the modulator material layer is a nematic curvilinear aligned phase (NCAP) film.

In some aspects, the plurality of liquid crystal droplets are randomly oriented while no electric field is present, wherein the plurality of liquid crystal droplets at least partially align along a direction of an electric field while the electric field is applied across the modulator material layer.

In some aspects, the modulator material layer includes: an additive, wherein the additive is an interface between the plurality of liquid crystal droplets and the polymer matrix.

An electro-optic modulator is described, in accordance with one or more embodiments of the present disclosure. The electro-optic modulator may include: a transparent conductive layer; a modulator material layer, wherein the transparent conductive layer is configured to apply an electric field across the modulator material layer, the modulator material layer including: a polymer matrix, wherein the polymer matrix includes a co-polymer which is polymerized from a first monomer, a second monomer, and a cross-linker; and a plurality of liquid crystal droplets dispersed within the polymer matrix; and a dielectric mirror film, wherein the modulator material layer is disposed between the transparent conductive layer and the dielectric mirror film.

In some aspects, the electro-optic modulator may include: a dielectric substrate, wherein the dielectric mirror film is disposed between the modulator material layer and the dielectric mirror film.

An imaging system is described, in accordance with one or more embodiments of the present disclosure. The imaging system may include: an illumination source configured to generate illumination; a stage for a sample; a detector to generate an image of at least a portion of the sample; and an electro-optic modulator disposed in a path of the illumination from the illumination source and separated from the sample by an air gap, wherein the electro-optic modulator includes: a transparent conductive layer, wherein the transparent conductive layer is configured to generate an electric field by capacitively coupling to the sample; a modulator material layer, wherein the transparent conductive layer is configured to apply the electric field across the modulator material layer, the modulator material layer including: a polymer matrix, wherein the polymer matrix includes a co-polymer which is polymerized from a first monomer, a second monomer, and a cross-linker; and a plurality of liquid crystal droplets dispersed within the polymer matrix; and a dielectric mirror film, wherein the modulator material layer is disposed between the transparent conductive layer and the dielectric mirror film.

A test cell is described, in accordance with one or more embodiments of the present disclosure. The test cell may include: a first glass substrate; a first transparent conductive layer coated on the first glass substrate; a second glass substrate; a second transparent conductive layer coated on the second glass substrate, wherein the first transparent conductive layer and the second transparent conductive layer are disposed between the first glass substrate and the second glass substrate, wherein the first transparent conductive layer and the second transparent conductive layer are configured to generate an electric field; and a modulator material layer, wherein the modulator material layer is disposed between the first transparent conductive layer and the second transparent conductive layer, wherein the first transparent conductive layer and the second transparent conductive layer are configured to apply the electric field across the modulator material layer, the modulator material layer including: a polymer matrix, wherein the polymer matrix includes a co-polymer which is polymerized from a first monomer, a second monomer, and a cross-linker; and a plurality of liquid crystal droplets dispersed within the polymer matrix.

A method is described, in accordance with one or more embodiments of the present disclosure. The method may include: mixing a liquid crystal material, a first monomer, a second monomer, and a cross-linker to form a mixture; coating a transparent conductive layer with the mixture; de-bubbling the mixture; and curing the mixture under ultraviolet light to form a modulator material layer including: a polymer matrix, wherein the polymer matrix includes a co-polymer which is polymerized from the first monomer, the second monomer, and the cross-linker; and a plurality of liquid crystal droplets dispersed within the polymer matrix, wherein the plurality of liquid crystal droplets are made of the liquid crystal material.

### BRIEF DESCRIPTION OF THE DRAWINGS

The numerous advantages of the disclosure may be better understood by those skilled in the art by reference to the accompanying figures in which:

FIG. 1 illustrates a cross-section view of an electro-optic modulator, in accordance with one or more embodiments of the present disclosure.

FIG. 2 illustrates a view of a modulator material layer of the electro-optic modulator, in accordance with one or more embodiments of the present disclosure.

FIG. 3 illustrates a plot of a voltage transmission (V-T) diagram for a test cell, in accordance with one or more embodiments of the present disclosure.

FIG. 4 illustrates a simplified view of an imaging system incorporating the electro-optic modulator, in accordance with one or more embodiments of the present disclosure.

FIG. 5 illustrates a cross-section view of a test cell with the modulator material layer, in accordance with one or more embodiments of the present disclosure.

FIG. 6 illustrates a flow diagram of a method for making the electro-optic modulator, in accordance with one or more embodiments of the present disclosure.

### DETAILED DESCRIPTION OF THE INVENTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to a formulation of an electro-optic modulator. The electro-optic modulator may include a modulator material layer. The modulator material layer may include a polymer matrix. Droplets of liquid crystals may be dispersed within the polymer matrix. The liquid crystals may modulate light transmissivity through the electro-optic modulator. The polymer matrix may include an acrylate-based matrix. The polymer matrix may reduce a switching voltage of the electro-optic modulator. The electro-optic modulator may be a component of an imaging system, also referred to as an automated optical inspection (AOI) system, a voltage imaging optical system (VIOS), an array checker, and the like. By reducing the switching voltage, process improvements of the optical inspection may be improved.

The acrylate-based matrix may include a formulation with a first monomer, second monomer, and cross-linker. The first monomer, second monomer, and cross-linker may include (meth)acrylate monomers. The first monomer may include a (meth)acrylate group and at least one of an alkane end group or a cycloalkane end group. The end groups may also be referred to as functionalization's or tails. The second monomer may include a (meth)acrylate group and a conjugated system end group. The conjugated system end group may include an aryl group. The cross-linker may include at least two (meth)acrylate groups. The conjugated system end group of the second monomer may anchor to liquid crystal droplets. The (meth)acrylate groups of the cross-linker may bond between the (meth)acrylate group of the first polymer and the (meth)acrylate group of the second polymer.

U.S. Pat. No. 5,432,461, titled “Method of testing active matrix liquid crystal display substrates”; U.S. Pat. No. 6,151,153, titled “Modulator transfer process and assembly”; U.S. Pat. No. 6,211,991, titled “Modulator manufacturing process and device”; U.S. Pat. No. 7,099,067, titled “Scratch and mar resistant PDLC modulator”, U.S. Pat. No. 7,639,319, titled “Polymer dispersed liquid crystal formulations for modulator fabrication”, U.S. Pat. No. 7,817,333, titled “Modulator with improved sensitivity and life time”; U.S. Pat. No. 8,801,964, titled “Encapsulated polymer network liquid crystal material, device and applications”; U.S. Pat. Pub. No. 2023/0392033, titled “Composition”; are each incorporated herein by reference in the entirety.

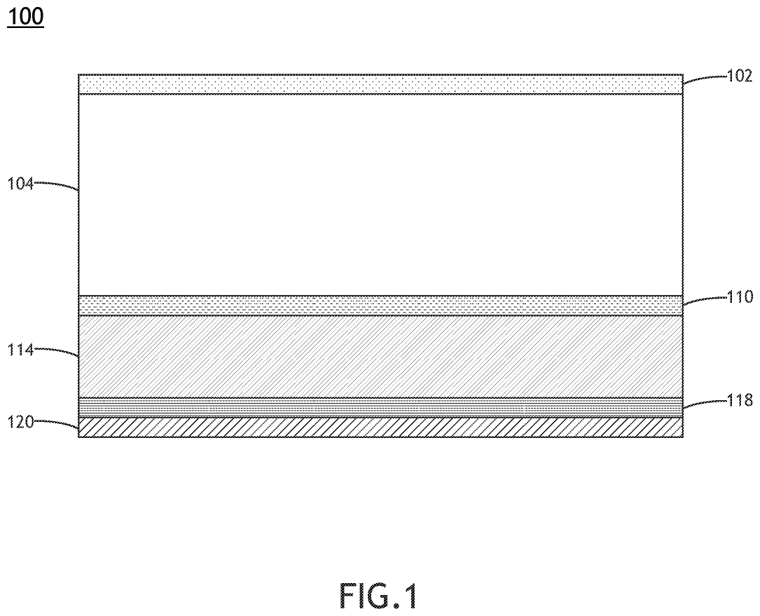

FIG. 1 is a cross-section view of an electro-optic modulator 100, in accordance with one or more embodiments of the present disclosure. The electro-optic modulator 100 may be referred to as an electro-optical light modulator, a liquid-crystal based electro-optical light modulator, and the like. The electro-optic modulator 100 may include one or more films, layers, or coatings. The one or more film layers may selectively permit the transmissivity of light. For example, the electro-optic modulator 100 may include one or more of an anti-reflective coating 102, glass substrate 104, transparent conductive layer 110, modulator material layer 114, dielectric mirror film 118, and/or dielectric substrate 120. It is further contemplated that the electro-optic modulator 100 is not intended to be limited to the films, layers, or coatings described above.

The anti-reflective coating 102 may be a dielectric anti-reflective stack of layers. The anti-reflective coating 102 may be disposed on an upper surface of the glass substrate 104. The anti-reflective coating 102 may include a selected thickness. For example, the anti-reflective coating 102 may include a thickness of from 0.1 to 0.5 micrometers.

The glass substrate 104 may include an optical glass, such as, but not limited to, a BK-7 glass, or the like. For example, the glass substrate 104 may be a cube or other cylindrically-shaped solid of BK-7 glass.

The transparent conductive layer 110 may be a transparent electrode. The transparent conductive layer 110 may include any material which is optically transparent and conductive to act as an electrode, such as, but not limited to, indium tin oxide (ITO) or other conductive material.

The transparent conductive layer 110 may be coated on the glass substrate 104. For example, the transparent conductive layer 110 may be coated on the glass substrate 104 without an intervening layer (e.g., without an intervening plastic film).

The transparent conductive layer 110 may be configured to generate an electric field. For example, the transparent conductive layer 110 may capacitively couple with a sample to induce a localized voltage. The localized voltage may generate the electric field.

The modulator material layer 114 may be made of liquid crystal containing sheets called Nematic Curvilinear Aligned Phase material (NCAP). A transmissivity of light through the modulator material layer 114, and similarly through the electro-optic modulator 100, may change in accordance with a magnitude of the electric field applied across the modulator material layer 114 by the transparent conductive layer 110. The modulator material layer 114 may be an electro-optic sensor which may be based on the light scattering characteristics of liquid crystal (herein after “LC”) droplets in a polymer matrix, for example nematic liquid crystal droplets in a polymer matrix (liquid crystal/polymer composite, or LC/polymer) film. The modulator material layer 114 may sense the electric field. The optical properties of the modulator material layer 114 change when the electrical field is applied across the modulator material layer 114. Intensity of light transmitted through the modulator material layer 114 may be modulated by variations in the electric field strength across the modulator material layer 114. Light transmission through the modulator material layer 114 may change in accordance with a magnitude of an electric field applied to the modulator material layer 114. The electric field may cause liquid crystals of the modulator material layer 114 to align in the direction of the electric field.

The modulator material layer 114 may include a selected thickness. For example, the modulator material layer 114 may include a thickness from 5 to 25 micrometers (um). For example, the modulator material layer 114 may include a thickness from 10 to 20 micrometers.

The modulator material layer 114 may be disposed between the transparent conductive layer 110 and the dielectric mirror film 118. The modulator material layer 114 may be coated on the transparent conductive layer 110 and/or the dielectric mirror film 118. For example, the modulator material layer 114 may be coated on the transparent conductive layer 110 and/or the dielectric mirror film 118 by casting by bar, blade, spin, press, capillary filling, injection, ink jet printing, smearing, dispensing, and the like.

The dielectric mirror film 118 may be disposed between the modulator material layer 114 and the dielectric substrate 120. The dielectric mirror film 118 may be a pellicle dielectric mirror, a quarter-wave mirror, or the like. The dielectric mirror film 118 may include a select thickness. For example, the dielectric mirror film 118 may have has a thickness of about 1.5 micrometers. The dielectric mirror film 118 may have reflectance for light with a desired wavelength. For example, the dielectric mirror film 118 may have from 75 to 95% reflectivity for light with a wavelength of 633 nanometers. The dielectric mirror film 118 may be a multilayer dielectric mirror. The multilayer dielectric mirror may include alternating layers of a first material and a second material. The dielectric mirror film 118 may include any number of the first material layers and the second material layers. For example, the dielectric mirror film 118 may include five of the first material layers and six of the second material layers for a total of eleven layers. The first material and second material may include any suitable material. For example, the dielectric mirror film 118 may be a zirconium dioxide (ZrO2)/silicon dioxide (SiO2) multilayer dielectric mirror. For instance, the dielectric mirror film 118 may include five of the ZrO2 layer and six of the SiO2 layers.

The dielectric substrate 120 may cover and protect the dielectric mirror film 118. The dielectric substrate 120 may include a plastic sheet, silicon dioxide (SiO2), or the like. The plastic sheet may include a polyester film comprising polyethylene terephthalate (PET), commercially available as Mylar®. For example, the dielectric substrate 120 may include a Mylar® Type C film. The dielectric substrate 120 may include a select thickness, such as, but not limited to, from 4 to 12 micrometers. The dielectric mirror film 118 and the dielectric substrate 120 may form a reflector. The dielectric mirror film 118 may be formed on the dielectric substrate 120, and then added to the modulator material layer 114 of the assembly stack.

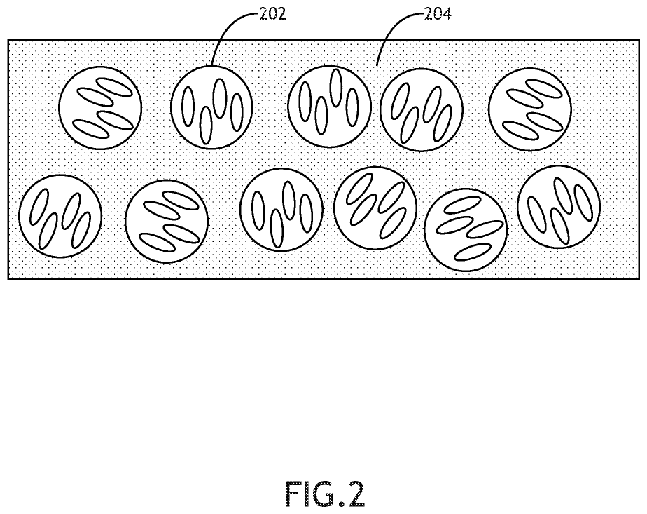

FIG. 2 is a cross-section view of the modulator material layer 114, in accordance with one or more embodiments of the present disclosure. The modulator material layer 114 may be an acrylate-based matrix liquid crystal NCAP. The modulator material layer 114 may include liquid crystal droplets 202 suspended in a polymer matrix 204.

The modulator material layer 114 includes the liquid crystal droplets 202. The liquid crystal droplets 202 each include several liquid crystal molecules. The liquid crystal droplets 202 may change phase when an electrical field is applied across the modulator material layer 114.

The liquid crystal droplets 202 may be include a select diameter. The liquid crystal droplets may range in size from 0.01 to 10 micrometers in diameter. For example, the liquid crystal droplets 202 may range in size from 0.1 to 1 micrometers in diameter.

The liquid crystal droplets 202 may include a select average size. The liquid crystal droplets 202 may include an average size from 0.1 to 1.5 micrometers in diameter. For example, the liquid crystal droplets 202 may include an average size from 0.3 to 1 micrometers in diameter. For instance, the liquid crystal droplets 202 may include an average size from 0.3 to 0.8 micrometers in diameter. The average size of the liquid crystal droplets 202 may be at or below 1 micrometer because the liquid crystal material from which the liquid crystal droplets 202 are formed is soluble within monomers from which the polymer matrix 204 is formed prior to polymerization and may experience nano- or micro-scale phase-separation during curing of the polymer matrix 204.

The liquid crystal droplets 202 may include any liquid crystal material. For example, the liquid crystal droplets 202 may include a nematic liquid crystal. The nematic liquid crystal may include any nematic liquid crystal, such as, but not limited to, MLC7022 commercially available as Licrystal® from EMD Performance Materials Corp, QYPDLC 036 from Qingdao QY Liquid Crystal Co., Ltd. (hereafter Qingdao), QYPDLC 421 from Qingdao, QYPDLC 901 from Qingdao, QYPDLC 193 from Qingdao, QYPDLC 203 from Qingdao, QYPDLC 20608U2 from Qingdao, or the like.

The liquid crystal material may include one or more aromatic rings. The liquid crystal material may also include one or more lipophilic tails. The lipophilic tails may include a long-chain hydrocarbon with three or more carbon atoms.

The liquid crystal droplets 202 may include a liquid crystal temperature range. The liquid crystal temperature range may refer to the temperature at which the liquid crystal is in a liquid crystal phase (e.g., between the crystal phase and the liquid phase). The liquid crystal temperature range may include 25 degrees Celsius, such that the liquid crystal droplets 202 may be in the liquid crystal phase at room temperature.

The liquid crystal droplets 202 may be from 50 wt. % to 80 wt. % of the modulator material layer 114. For example, the liquid crystal droplets 202 may be may be 50 wt. %, 60 wt. %, 65 wt. %, 67 wt. %, 68 wt. %, 69 wt. %, 70 wt. %, 71 wt. %, 72 wt. %, 80 wt. %, or a value therebetween of the modulator material layer 114. In embodiments, the liquid crystal droplets 202 may be from 60 wt. % to 75 wt. % of the modulator material layer 114. For example, the liquid crystal droplets 202 may be from 68 wt. % to 72 wt. % of the modulator material layer 114. For instance, the liquid crystal droplets 202 may be from 69 wt. % to 71 wt. % of the modulator material layer 114.

The modulator material layer 114 may also include the polymer matrix 204. The polymer matrix 204 may include any polymer matrix material. In embodiments, the polymer matrix 204 is an acrylate-based polymer matrix. The polymer matrix 204 may be a co-polymer. The polymer matrix 204 may be a co-polymer which is polymerized from one or more monomers. In embodiments, the polymer matrix 204 may be a co-polymer which may be polymerized from a first monomer, a second monomer, a cross-linker, and/or a photo-initiator. The first monomer may be different than the second monomer.

The term “(meth)acrylate” means either acrylate or methacrylate.

The first monomer from which the polymer matrix 204 is polymerized may include a (meth)acrylate group and may not include a conjugated system end group, such as an aromatic ring. The first monomer may include a lipophilic behavior without the aromatic ring. The first monomer may include the following chemical formula:

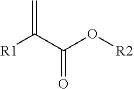

The first monomer may include the (meth)acrylate group. The (meth)acrylate group may include R1, where R1 is one of H (e.g., the (meth)acrylate group is acrylate) or CH3 (e.g., the (meth)acrylate group is methacrylate).

The first monomer may include R2. R2 may bond to the (meth)acrylate group. For example, R2 may bond to the oxygen (O) of the (meth)acrylate group. R2 may include an alkane end group (e.g., a straight alkane chain having 1 to 25 carbon atoms) or a cycloalkane end group (e.g., a cycloalkane having 3 to 25 carbon atoms). R2 may not include a conjugated system end group. By not including the conjugated system group, R2 may not include any conjugated carbon-to-carbon single and double bonds. For example, R2 may not include a conjugated hydrocarbon chain or an aromatic ring. R2 may not include the conjugated system end group to provide only Van-Der Waals interactions between R2 and the liquid crystal material and prevent stronger interactions between R2 and the liquid crystal material. The first monomer may be a mono-(meth)acrylate monomer. R2 may not include an additional (meth)acrylate group.

For example, the first monomer from which the polymer matrix 204 is polymerized may be lauryl acrylate (LA), also known as dodecyl acrylate, with the following chemical formula:

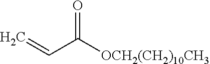

By way of another example, the first monomer from which the polymer matrix 204 is polymerized may be isobornyl acrylate, also known as acrylic acid isobornyl ester, with the following chemical formula:

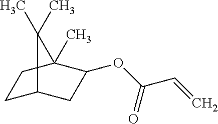

The first monomer may be from 5 wt. % to 13 wt. % of the modulator material layer 114. For example, the first monomer may be 5 wt. %, 6 wt. %, 7 wt. %, 7.75 wt. %, 8 wt. %, 9 wt. %, 10 wt. %, 13 wt. %, or a value therebetween of the modulator material layer 114. In embodiments, the first monomer may be from 6 wt. % to 10 wt. % of the modulator material layer 114. For example, the first monomer may be from 7 wt. % to 8 wt. % of the modulator material layer 114.

The second monomer from which the polymer matrix 204 is polymerized may include a (meth)acrylate group and may include a conjugated system end group. The second monomer may include the following chemical formula:

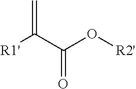

The second monomer may include the (meth)acrylate group. The (meth)acrylate group may include R1′, where R1′ is one of H (e.g., the (meth)acrylate group is acrylate) or CH3 (e.g., the (meth)acrylate group is methacrylate).

The second monomer may include R2′. R2′ may bond to the (meth)acrylate group. For example, R2′ may bond to the O of the (meth)acrylate group. R2′ may include the conjugated system end group. By including the conjugated system end group, R2′ may include conjugated carbon-to-carbon single and double bonds. For example, the conjugated system end group may include a conjugated hydrocarbon chain or an aromatic ring. The aromatic ring may be an aryl group such as, but not limited to, a phenyl group, a naphthyl group, a substituent thereof. The second monomer may be a mono-(meth)acrylate monomer. R2′ may not include an additional (meth)acrylate group.

The second monomer from which the polymer matrix 204 is polymerized may include an ether group. R2′ may include the ether group. The second monomer may include the following chemical formula:

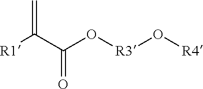

The ether group may include R3′, O, and R4′. The O of the ether group may bond between R3′ and R4′.

R3′ may bond between the O of the (meth)acrylate group and the O of the ether group. R3′ may include a straight alkane chain having 1 to 25 carbon atoms, a cycloalkane having 3 to 25 carbon atoms, one or more aromatic rings, or the like.

R4′ may include the conjugated system end group. For example, the conjugated system end group may include the conjugated hydrocarbon chain or the aromatic ring. For instance, the aromatic ring may be an aryl group such as, but not limited to, a phenyl group, a naphthyl group, a substituent thereof.

The second monomer may include the following formula where R4′ is the phenyl group:

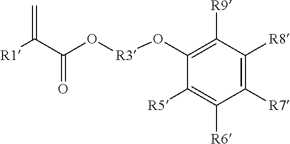

The phenyl group may include a cyclic group of six carbons (C) and R5′, R6′, R7′, R8′, and R9′. A first carbon of the cyclic group of six carbons may bond to the O of the ether group. R5′, R6′, R7′, R8′, and R9′ may bond to the remainder of the carbons in the cyclic group. R5′, R6′, R7′, R8′, and R9′ may include H, F (e.g., the phenyl group may be a fluorinated phenyl group), and the like.

For example, the second monomer from which the polymer matrix 204 is polymerized may be ethylene glycol phenyl ether acrylate (EGPEA), also known as 2-phenoxyethyl acrylate, with the following chemical formula:

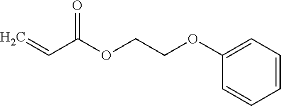

Although the second monomer is described as including an ether group with R2′, O, and R3′, this is not intended as a limitation of the present disclosure. The second monomer may not include R2′ and O. Instead, the (meth)acrylate group may share the O with R3′.

For example, the second monomer from which the polymer matrix 204 is polymerized may be Pentafluorophenyl acrylate, also known as 2-Propenoic acid pentafluorophenyl ester, with the following chemical formula:

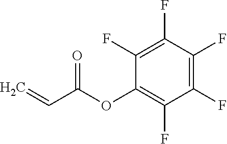 [SMILES: C=CC(=O)Oc1c(F)c(F)c(F)c(F)c1F]

By way of another example, the second monomer from which the polymer matrix 204 is polymerized may be 2-Naphthyl acrylate, with the following chemical formula:

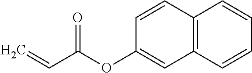

The second monomer may be from 7 wt. % to 17 wt. % of the modulator material layer 114. For example, the second monomer may be 7 wt. %, 10 wt. %, 11.5 wt. %, 13 wt. %, 14 wt. %, 15 wt. %, 16 wt. %, 17 wt. %, or a value therebetween of the modulator material layer 114. In embodiments, the second monomer may be from 13 wt. % to 15 wt. % of the modulator material layer 114.

The cross-linker from which the polymer matrix 204 is polymerized may be a multi-(meth)acrylate monomer with at least two (meth)acrylate groups. The first monomer may include the following chemical formula:

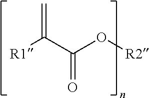

The cross-linker may include the (meth)acrylate groups. The cross-linker may include n number of the (meth)acrylate groups, where n is 2, 3, or 4. In this regard, the cross-linker may be a di-(meth)acrylate monomer with two (meth)acrylate groups, a tri-(meth)acrylate monomer with three (meth)acrylate groups, or a tetra-(meth)acrylate monomer with four (meth)acrylate groups, respectively.

The (meth)acrylate groups may include R1″, where R1″ is one of H (e.g., the (meth)acrylate group is acrylate) or CH3 (e.g., the (meth)acrylate group is methacrylate).

The cross-linker may include R2″. R2″ may bond between the O of the (meth)acrylate groups. R2″ may include a straight alkane chain having 1 to 25 carbon atoms, a cycloalkane having 3 to 25 carbon atoms, one or more aromatic rings, ester groups, or the like.

For example, the cross-linker from which the polymer matrix 204 is polymerized may be 1,6-Hexanediol diacrylate (HDDA), with the following chemical formula:

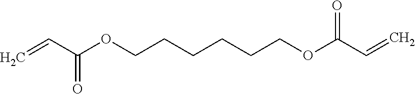 [SMILES: C=CC(=O)OCCCCCCOC(=O)C=C]

By way of another example, the cross-linker from which the polymer matrix 204 is polymerized may be 1,4-Phenylene dimethacrylate, also known as (1,4-phenylene) ester, also known as 1,4-Phenylene bismethacrylate, also known as 2-Methyl-2-propenoic acid, with the following chemical formula:

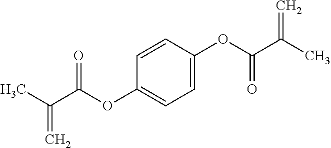 [SMILES: C=C(C)C(=O)Oc1ccc(OC(=O)C(=C)C)cc1]

By way of another example, the cross-linker from which the polymer matrix 204 is polymerized may be Bisphenol A dimethacrylate (BPADMA), also known as 2,2-Bis(4-hydroxyphenyl) propane dimethacrylate, also known as 2,2-Bis(4-methacryloxyphenyl) propane, also known as 2,2-Bis(4-methacryloyloxyphenyl) propane, also known as 4,4′-Isopropylidenediphenol dimethacrylate, with the following chemical formula:

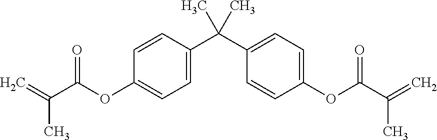 [SMILES: C=C(C)C(=O)Oc1ccc(C(C)(C)c2ccc(OC(=O)C(=C)C)cc2)cc1]

By way of another example, the cross-linker from which the polymer matrix 204 is polymerized may be 1,4-Bis[4-(3-acryloyloxypropoxy)benzoyloxy]-2-methylbenzene, also known as 2-Methyl-1,4-phenylene bis(4-(3-(acryloyloxy)propoxy)benzoate), with the following chemical formula:

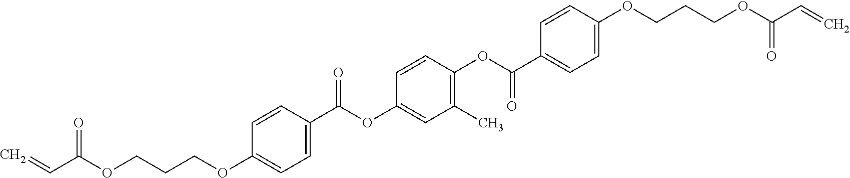 [SMILES: C=CC(=O)OCCCOc1ccc(C(=O)Oc2ccc(OC(=O)c3ccc(OCCCOC(=O)C=C)cc3)c(C)c2)cc1]

By way of another example, the cross-linker from which the polymer matrix 204 is polymerized may be 2-Methyl-1,4-phenylene Bis[4-[[[4-(acryloyloxy)-butoxy]carbonyl]oxy]benzoate], with the following chemical formula:

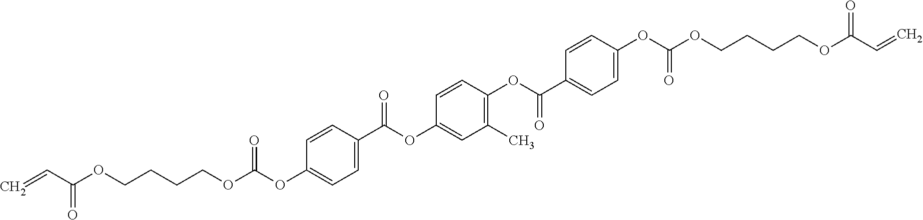 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

By way of another example, the cross-linker from which the polymer matrix 204 is polymerized may be trimethylolpropane trimethacrylate, also known as TMPTMA, with the following chemical formula:

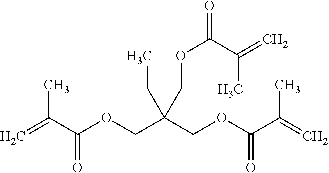 [SMILES: C=C(C)C(=O)OCC(CC)(COC(=O)C(=C)C)COC(=O)C(=C)C]

By way of another example, the cross-linker from which the polymer matrix 204 is polymerized may be pentaerythritol tetracrylate, also known as PETRA, with the following chemical formula:

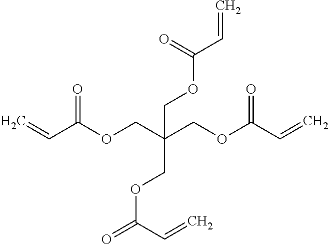 [SMILES: C=CC(=O)OCC(COC(=O)C=C)(COC(=O)C=C)COC(=O)C=C]

The cross-linker may be from 1 wt. % to 10 wt. % of the modulator material layer 114. For example, the cross-linker may be 1 wt. %, 2 wt. %, 3 wt. %, 5 wt. %, 6 wt. %, 7 wt. %, 7.75 wt. %, 8 wt. %, 10 wt. %, or a value therebetween of the modulator material layer 114. In embodiments, the cross-linker may be from 6 wt. % to 8 wt. % of the modulator material layer 114. In embodiments, the cross-linker may be from 1 wt. % to 3 wt. % of the modulator material layer 114.

The photo-initiator may be soluble in the liquid crystal droplets 202 to polymerize and crosslink the first monomer, the second monomer, and the cross-linker into the polymer matrix 204. Examples of suitable photo-initiators include Irgacure® series and Darocur™ series from Ciba Specialty Chemicals, Lucirin™ TPO from BASF, and Escure™ series from Sartomer.

For example, the photo-initiator from which the polymer matrix 204 is polymerized may be Bis(2,4,6-trimethylbenzoyl)-phenylphosphineoxide, commercially available as Irgacure 819, with the following chemical formula:

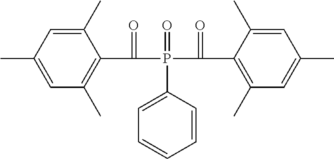

The photo-initiator may be from 0 wt. % to 3 wt. % of the modulator material layer 114. For example, the photo-initiator may be 0.3 wt. %, 0.4 wt. %, 0.5 wt. %, 0.6 wt. %, 0.7 wt. %, 1 wt. %, 1.25 wt. %, 1.5 wt. %, 2 wt. %, 3 wt. %, 4 wt. %, 4.6 wt. %, or a value therebetween of the modulator material layer 114. In embodiments, the photo-initiator may be from 0.4 wt. % to 0.6 wt. % of the modulator material layer 114.

Although the polymer matrix 204 is described as including the photo-imitator, this is not intended as a limitation of the present disclosure. It is contemplated that the first monomer, the second monomer, and the cross-linker may be polymerized into the polymer matrix 204 without the photo-initiator.

The polymer matrix 204 may also include one or more additives. The one or more additives may not include a (meth)acrylate group. The one or more additives may include one or more aromatic rings.

For example, the additives may include 1-Phenyl-1-cyclohexene, with the following chemical formula:

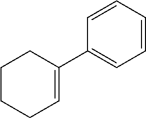 [SMILES: C1=C(c2ccccc2)CCCC1]

The additives may not be dissolved within the liquid crystal droplets 202 and/or the polymer matrix 204. The additives may be an interfacial agent. The additives may be an interface between the liquid crystal droplets 202 and/or the polymer matrix 204. The additives may improve the uniformity of the modulator material layer 114 and/or the electro-optical properties of the modulator material layer 114. For example, the additives may reduce a switching voltage at which the modulator material layer 114 becomes transparent, improve a hysteresis of the modulator material layer 114, or the like.

The additives may be from 0.5 wt. % to 5.0 wt. % of the modulator material layer 114.

In embodiments, the polymer matrix 204 may include a formulation with the first monomer as lauryl acrylate, the second monomer as EGPEA, and the cross-linker as HDDA.

The polymer matrix 204 may be located around the liquid crystal droplets 202 and may contain the liquid crystal droplets 202 with the polymer matrix 204. The liquid crystal droplets 202 may be dispersed within the polymer matrix 204. The CH2 of the (meth)acrylate groups of the first monomer, the cross-linker, and the second monomer may bond the first monomer, the cross-linker, and the second monomer via microphase separation. For example, the (meth)acrylate groups of the cross-linker may radically polymerize between the (meth)acrylate group of the first monomer and (meth)acrylate group of the second monomer, thereby cross-linking the first monomer with the second monomer.

The (meth)acrylate groups may interact with the liquid crystal molecules via Van Der Waals forces and dipole-dipole interactions (e.g., Pi stacking) before polymerization the monomers into the polymer matrix 204. Thus, the (meth)acrylate groups of the liquid crystal material, the second monomer, and/or the cross-linker may dissolve the liquid crystal molecules before polymerization.

The (meth)acrylate groups may not interact via dipole-dipole interactions with the liquid crystal droplets 202 after polymerization into the polymer matrix 204 due to losing a Pi-bond during polymerization. Thus, the (meth)acrylate groups of the liquid crystal material, the second monomer, and/or the cross-linker may not completely dissolve the liquid crystal molecules.

The liquid crystal droplets 202 may anchor to the polymer matrix 204. The degree of anchoring may depend on the chemistry of the liquid crystal droplets 202 and polymer matrix 204. The amount of polymer matrix 204 material may correspond to the strength and rigidity of the modulator material layer 114. Increases to the amount of polymer matrix 204 material may increase the strength of the modulator material layer 114 and the operating voltage. The aromatic rings of the liquid crystal material, the conjugated system end group of R2′ of the second monomer, and optionally the aromatic rings of R2″ of the cross-linker may interact via dipole-dipole interactions (e.g., Pi-stacking). The dipole-dipole interactions may anchor the liquid crystal material to the conjugated system end group of R2′ of the second monomer and optionally to the aromatic ring of R2″ of the cross-linker. The anchoring may reduce phase-separation. The anchoring may cause a decrease in a droplet size of the liquid crystal droplets 202, provide a higher uniformity in the droplet size, provide a more even distribution of the liquid crystal droplets 202, an increase in the operating voltage, a reduction in sensitivity, and the like.

The liquid crystal droplets 202 may be randomly oriented while no electric field is present. The liquid crystal droplets 202 may at least partially align along the electric field direction while the electric field is applied across the modulator material layer 114. For such alignment to occur, the liquid crystal droplets 202 may overcome the anchoring and/or friction with the polymer matrix 204 at the attachment locus. The orientation of the liquid crystal droplets 202 may then change the transmissivity of the modulator material layer 114. For example, the modulator material layer 114 may be opaque when no voltage is applied and the liquid crystals are randomly oriented. The modulator material layer 114 may be transparent or translucent when voltage is applied, and the liquid crystal droplets 202 may at least partially align. The liquid crystal droplets 202 may then return to the random orientation when the electric field is removed. In this regard, the modulator material layer 114 may exhibit an electro-optic effect of electric field dependent light scattering.

The liquid crystal droplets 202 may be birefringent. In this regard, the refract index of the liquid crystal droplets 202 may depend on the polarization direction of the liquid crystal droplets 202. The polarization direction may be based on a direction of the electric field induced by the transparent conductive layer 110. The liquid crystal droplets 202 may include an ordinary refractive index (no) and an extraordinary refractive index (ne). The ordinary refractive index may be the index of refraction when the electric field is not applied across the modulator material layer 114 and the extraordinary refractive index may be the index of refraction when the electric field is applied across the modulator material layer 114. The extraordinary refractive index may be higher than the ordinary refractive index. The birefringence (Δn) of the liquid crystal droplets 202 may be the difference between the extraordinary refractive index and the ordinary refractive index. The birefringence may be any selected value, such as a birefringence from 0.01 to 0.4. For example, the birefringence may be from 0.08 to 0.12. Increases in the birefringence may cause the modulator material layer 114 to be more sensitive to the electric-field.

The liquid crystal droplets 202 may include a select dielectric anisotropy (Δε). The dielectric anisotropy may be based on a parallel dielectric constant (ε∥) and a perpendicular dielectric constant (ϵ⊥) of the liquid crystal droplets 202. For example, the dielectric anisotropy may be from 5 to 15. For instance, the dielectric anisotropy may be from 8 to 13.

An index of refraction of the polymer matrix 204 and the ordinary refractive index of the liquid crystal droplets 202 may be the same. Thus, the liquid crystal droplets 202 may blend into the polymer matrix 204 when at the ordinary refractive index (e.g., when the electric field is applied).

The liquid crystal droplets 202 may include the switching voltage. The switching voltage may also be referred to as a turn-on voltage. The intrinsic switching voltage of the liquid crystals may correspond to a voltage across the modulator material layer at which light transmission through electro-optic modulator has a maximum sensitivity to changes in the voltage. In embodiments, the switching voltage may correspond to the electric field strength at which about half of the liquid crystal molecules are substantially aligned with the electric field. Providing larger changes in transmission for the smaller voltage changes may provide a better sensitivity. The sensitivity can be improved by reducing the intrinsic switching voltage of the liquid crystal material. The operating voltage and sensitivity of liquid crystal materials may be related to one or more factors, such as, but not limited to, properties of the liquid crystal droplets 202, properties of the polymer matrix 204, a size of the liquid crystal droplets 202, distribution of the liquid crystal droplets 202 in the polymer matrix 204, and/or interface properties between the liquid crystal droplets 202 and the polymer matrix 204. In embodiments, the liquid crystal droplets 202 may include a response time from 2 to 6 milliseconds at a light transmission from 35 to 55 percent.

The liquid crystal droplets 202 may anchor to the polymer matrix 204. A degree of anchoring may depend on the liquid crystal droplets 202 and polymer matrix 204 chemistries. When an electric field is applied across the modulator material layer 114, the liquid crystal droplets 202 may at least partially align along the electric field direction. For such alignment to occur, the liquid crystal droplets 202 may overcome the anchoring and/or friction with the polymer at an attachment locus. Anchoring of the liquid crystal droplets 202 to the polymer matrix 204 may increase the intrinsic operating voltage of the modulator material layer 114. Frictional forces may include anchoring forces that may be associated with static friction of the liquid crystal droplets 202 to the polymer matrix 204 and may also include dynamic friction associated with relative motion between the liquid crystal droplets 202 and the polymer matrix 204. As friction may affect the speed at which the liquid crystal droplets 202 move in relation to the polymer matrix 204, decreased friction may increase the switching speed of the liquid crystal droplets 202. As an increase in voltage may be required to overcome anchoring of the liquid crystal droplets 202 to the polymer matrix 204, increased anchoring may be related to an increased intrinsic operating voltage of the modulator material layer 114. Thus, the lower the frictional force and/or anchoring, between the liquid crystal droplets 202 and the polymer matrix 204, the lower the driving voltage required to switch the liquid crystal droplets 202 from a substantially unaligned condition to a condition substantially aligned with the electric field. It is contemplated that the formulation of the polymer matrix 204 may reduce the anchoring between the liquid crystal droplets 202 and the polymer matrix 204.

The concentration of the second monomer may control the switching voltage of the modulator material layer 114. For example, the switching voltage may be increased by increasing the concentration of the second monomer, thereby increasing the anchoring between the liquid crystal droplets 202 and the polymer matrix 204 (e.g., the aryl groups of the second monomer of the polymer matrix 204). Thus, controlling the amount of the second monomer may control both a size of the liquid crystal droplets 202 and the switching voltage of the modulator material layer 114.

A length of R2″ may affect the switching voltage of the modulator material layer 114. For example, the length of R2″ may impact the interaction between the cross-linker and the liquid crystal material. Where the R2″ has a longer chain, the modulator material layer 114 may have a lower switching voltage because the cross-linker has more degree of freedom to untangle. In this regard, the wt. % of the cross-linker may be increased where the R2″ has a shorter chain and decreased where the R2″ has a longer chain.

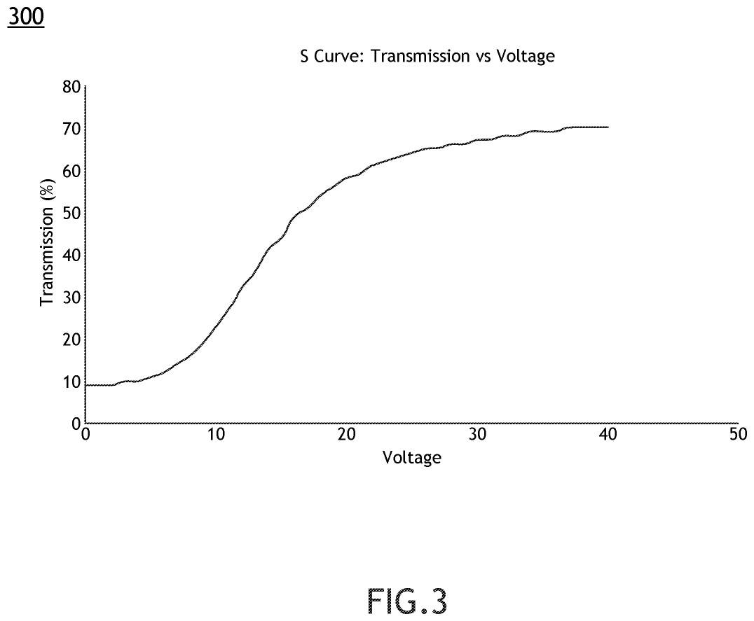

FIG. 3 illustrates a graph 300, in accordance with one or more embodiments of the present disclosure. In this example, an NCAP sample was analyzed where the NCAP sample was made with the liquid crystal, lauryl acrylate, HDDA, EGPEA, and photo-initiator. In this example, the graph 300 is for a test cell (e.g., test cell 500) with the modulator material layer 114 by a laser tester in a transmission mode operated at 0-to-40-volts. Similar results may be found for the electro-optic modulator 100 with the modulator material layer 114 operated at high voltages with a multiple-times scaling applied to the x-axis of the graph 300.

The slope of the curve may be affected by the droplet size distribution and the interface properties between the polymer matrix 204 and liquid crystal droplets 202. A steeper slope may result if the liquid crystal droplets 202 are of uniform size and if the liquid crystals within the liquid crystal droplets 202 can move and/or switch easily relative to the polymer matrix 204. The voltage shift of the curve shown may be affected by the interface properties between the polymer matrix 204 and liquid crystal droplets 202, a size of the liquid crystal droplets 202, a thickness of the modulator material layer 114, haze/phase separation kinetics (induced during polymerization and curing), and the like. The curve may shift to lower voltage if the liquid crystal can move and/or switch easily relative to the polymer matrix 204. It is contemplated that the formulation of the polymer matrix 204 may make the T-V curve slope steeper and to shift the operating voltage of liquid crystal material to a lower range.

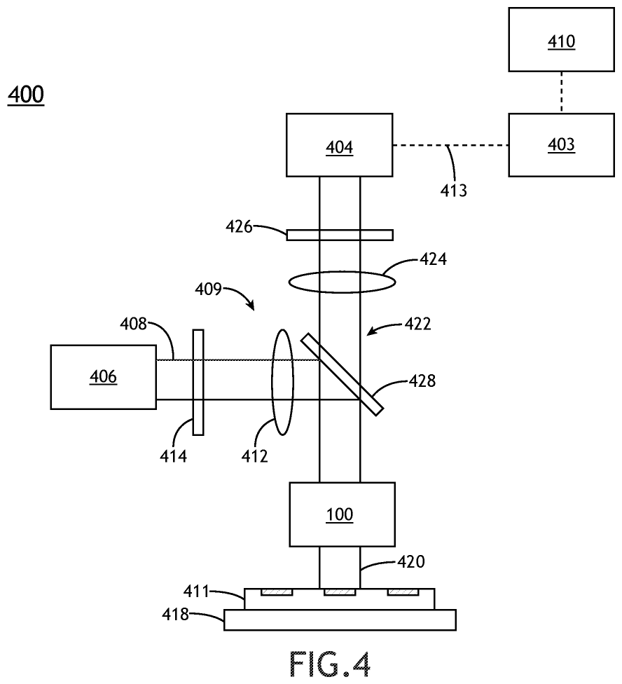

FIG. 4 is a conceptual view illustrating an imaging system 400, in accordance with one or more embodiments of the present disclosure. For the purposes of the present disclosure, the term ‘imaging system’ is interchangeable with the term ‘imaging tool.’ The imaging system 400 may be an automated optical inspection (AOI) system, a voltage imaging optical system (VIOS), an array checker, and the like.

The imaging system 400 may generally include any type of imaging tool suitable, such as, but not limited to, voltage imaging. Voltage imaging may be employed to detect and measure defects in flat panel thin film transistors (TFT) arrays. The performance of the TFT array is simulated as if it were assembled into a TFT cell and then the characteristics of the TFT array are measured by indirectly measuring actual voltage distribution on the panel, or so-called voltage imaging, using an electro-optic modulator (e.g., electro-optic modulator 100). The voltage imaging may be performed by the imaging system 400. The imaging system 400 may include one or more components for checking such TFT arrays or other samples.

The electro-optic modulator 100 may be advantageous for several imaging tasks, such as to modulate a light source of the imaging system 400 to assist in detecting one or more defects of a sample 411, such as, but not limited to, thin film transistor (TFT) arrays, liquid crystal display (LCD) panels, OLED panels, and the like. The TFT arrays may be formed on a substrate, such as a clear plate of thin glass. The TFT arrays may include one or more printed layers. The printed layers may be formed on the substrate by several processes, such as, but not limited to, one or more material deposition steps, one or more lithography steps, one or more etching steps, and the like. The fabrication may occur in stages, where a material (e.g., indium tin oxide (ITO), etc.) is deposited over a previous layer or on the glass substrate, according to a process pattern. During fabrication, the printed layers are fabricated within selected tolerances to properly construct the final device. The printed layers may exhibit defects which are outside of the selected tolerances. Characteristics of the TFT array may be measured by the imaging system 400 to detect the defects.

In embodiments, the imaging system 400 may include an illumination source 406 to generate illumination 408. The illumination 408 may include one or more selected wavelengths of light including, but not limited to, vacuum ultraviolet radiation (VUV), deep ultraviolet radiation (DUV), ultraviolet (UV) radiation, visible radiation, or infrared (IR) radiation. The illumination source 406 may further generate illumination 408 including any range of selected wavelengths. In embodiments, the illumination source 406 may include a spectrally-tunable illumination source to generate illumination 408 having a tunable spectrum.

In embodiments, the illumination source 406 may direct the illumination 408 to a sample 411 via an illumination pathway 409. The illumination pathway 409 may include one or more lenses 412 or illumination optical components 414 suitable for modifying and/or conditioning the illumination 408. For example, the illumination optical components 414 may include, but are not limited to, one or more polarizers, one or more filters, one or more beam splitters, one or more diffusers, one or more homogenizers, one or more apodizers, one or more shapers, one or more shutters (e.g., mechanical shutters, electro-optical shutters, acousto-optical shutters, or the like), one or more aperture stops, and/or one or more field stops.

In embodiments, the imaging system 400 may include the electro-optic modulator 100. The electro-optic modulator 100 may be disposed in a path of the illumination 408 from the illumination source 406. The electro-optic modulator 100 may modulate one or more characteristics of the illumination 408. During operation, light may transmit through portions of the electro-optic modulator 100, and defects may be detected by observing changes in the reflected or transmitted light. The electro-optic modulator 100 may be separated from the sample 411 by an air gap. The electro-optic modulator 100 may be placed a select number of micrometers (e.g., between 5-75 micrometers) above the surface of the sample 411 (e.g., the TFT array), and a voltage bias is applied across a transparent electrode of a layer of indium tin oxide (hereinafter “ITO”) on a surface of the electro-optic modulator 100. Thereupon, the electro-optic modulator 100 may capacitively couple to the sample 411 so that an electric field associated with the sample 411 may be sensed by one or more layers of the electro-optic modulator 100 (e.g., a layer including liquid crystals). The intensity of incident light transmitted through the liquid crystals of the electro-optic modulator may be varied, (i.e., modulated), based on the electric field strength felt by the liquid crystals. For example, in areas where a normal pixel is located, a localized voltage potential may be impressed (e.g., a capacitive coupling between the sample 411 and the electro-optic modulator 100) causing one or more films of the electro-optic modulator 100 to be locally translucent. In the locally translucent regions, light from the illumination source 406 may pass through the electro-optic modulator 100 and reflect from the sample 411, for passing through to a collection pathway 422 (e.g., for capture by detector 404). By way of another example, in areas where no voltage potential is impressed (e.g., no capacitive coupling), one or more films of the electro-optic modulator 100 may remain locally opaque. In the case where the electro-optic modulator 100 is locally opaque, light from illumination source 406 may be scattered or otherwise prevented from passing through to the sample 411. Thus, a transmission-voltage (T-V) curve may be determined by applying the voltage. The intrinsic switching voltage of the electro-optic modulator 100 may correspond to the voltage across the electro-optic modulator 100 at which light transmission through the electro-optic modulator 100 has a maximum sensitivity to a change in voltage. For example, the switching voltage may correspond to the electric field strength at which a given percentage of liquid crystal molecules are substantially aligned with the electric field allowing for the light transmission.

In embodiments, the sample 411 may include a thin-film transistor (TFT) array. For example, the sample 411 may include pixel elements disposed between inactive regions. The sample stage 418 may include any device suitable for positioning the sample 411 within the imaging system 400.

In embodiments, a detector 404 may be configured to capture radiation emanating from the sample 411 (e.g., sample light 420) through a collection pathway 422. For example, the collection pathway 422 may include, but is not required to include, the electro-optic modulator 100, a collection lens (e.g., an objective lens), or collection pathway lenses 424. In this regard, the detector 404 may receive radiation reflected or scattered (e.g., via specular reflection, diffuse reflection, and the like) from the sample 411 or generated by the sample 411 (e.g., luminescence associated with absorption of the illumination 408, or the like).

The imaging system 400 may include, but is not limited to, a controller 403. The controller 403 may include one or more processors and memory, and may include or be coupled to a user interface 410.

The collection pathway 422 may further include any number of collection optical components 426 to direct and/or modify illumination collected by the electro-optic modulator 100 including, but not limited to collection pathway lenses 424, one or more filters, one or more polarizers, or one or more blocks. Additionally, the collection pathway 422 may include field stops to control the spatial extent of the sample imaged onto the detector 404 or aperture stops to control the angular extent of illumination from the sample used to generate an image on the detector 404. In embodiments, the collection pathway 422 may include an aperture stop located in a plane conjugate to the back focal plane of an optical element to provide telecentric imaging of the sample. In embodiments, the imaging system 400 may include a beam splitter 428 oriented such that the electro-optic modulator 100 may simultaneously direct the illumination 408 to the sample 411 and collect radiation emanating from the sample 411.

The detector 404 may include any type of optical detector suitable for measuring illumination received from the sample 411. For example, the detector 404 may include, but is not limited to, a CCD detector, a TDI detector, a photomultiplier tube (PMT), an avalanche photodiode (APD), a complementary metal-oxide-semiconductor (CMOS) sensor, or the like. In embodiments, the detector 404 may include a spectroscopic detector suitable for identifying wavelengths of light emanating from the sample 411.

In embodiments, the controller 403 may be communicatively coupled to a detector 404. The controller 403 may include one or more processors configured to execute any of various process steps. In embodiments, the controller 403 may be configured to generate and provide one or more control signals configured to perform one or more adjustments to one or more process tools based on image signals 413 from the detector 404.

The one or more processors of the controller 403 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the imaging system 400, as described throughout the present disclosure. Moreover, different subsystems of the imaging system 400 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 403 may include one or more controllers housed in a common housing or within multiple housings. In this way, any controller or combination of controllers may be separately packaged as a module suitable for integration into imaging system 400. Further, the controller 403 may analyze data received from the detector 404 and feed the data to additional components within the imaging system 400 or external to the imaging system 400.

The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller. For instance, the one or more processors of controller 403 may access a remote memory (e.g., server), accessible through a network (e.g., internet, intranet and the like).

In embodiments, the user interface 410 may be communicatively coupled to the controller 403. In embodiments, the user interface 410 may include, but is not limited to, one or more desktops, laptops, tablets, and the like. In embodiments, the user interface 410 includes a display used to display data of the imaging system 400 to a user. The display of the user interface 410 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 410 is suitable for implementation in the present disclosure. In embodiments, a user may input selections and/or instructions responsive to data displayed to the user via a user input device of the user interface 410.

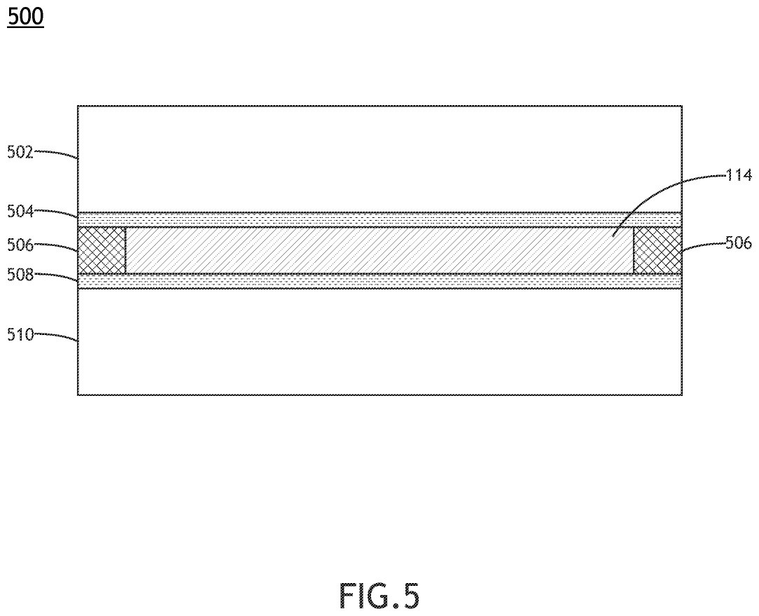

FIG. 5 is a cross-section view of a test cell 500, in accordance with one or more embodiments of the present disclosure. The test cell 500 may include one or more of a glass substrate 502, a transparent conductive layer 504, spacers 506, the modulator material layer 114, a transparent conductive layer 508, and/or a glass substrate 510.

The glass substrate 502 and/or the glass substrate 510 may include an optical glass, such as, but not limited to, a BK-7 glass, or the like. For example, the glass substrate 502 and/or the glass substrate 510 may be a cube or other cylindrically-shaped solid of BK-7 glass.

The transparent conductive layer 504 and/or the transparent conductive layer 508 may be a transparent electrode. The transparent conductive layer 504 and/or the transparent conductive layer 508 may include any material which is optically transparent and conductive to act as an electrode, such as, but not limited to, indium tin oxide (ITO) or other conductive material.

The transparent conductive layer 504 and the transparent conductive layer 508 may be coated on the glass substrate 502 and the glass substrate 510, respectively. For example, the transparent conductive layer 504 and the transparent conductive layer 508 may be coated on the glass substrate 502 and the glass substrate 510, respectively, without an intervening layer (e.g., without an intervening plastic film). The transparent conductive layer 504 and the transparent conductive layer 508 may be disposed between the glass substrate 502 and the glass substrate 510.

The transparent conductive layer 504 and/or the transparent conductive layer 508 may be configured to generate an electric field. For example, the transparent conductive layer 504 and/or the transparent conductive layer 508 may capacitively couple together to induce a localized voltage. The localized voltage may generate the electric field.

The spacers 506 may separate the transparent conductive layer 504 and the transparent conductive layer 508. For example, the spacers 506 may separate the transparent conductive layer 504 and the transparent conductive layer 508 to define a capillary between the transparent conductive layer 504 and the transparent conductive layer 508. The spacers 506 may support the glass substrate 502 and the transparent conductive layer 504 through the transparent conductive layer 508 and the glass substrate 510 while the polymer matrix 204 of the modulator material layer 114 is cured.

The modulator material layer 114 may be disposed between the transparent conductive layer 504 and the transparent conductive layer 508. For example, the modulator material layer 114 may be disposed within a capillary defined between the transparent conductive layer 504 and the transparent conductive layer 508. A thickness of the modulator material layer 114 may be between 15 and 20 micrometers.

The transparent conductive layer 504 and/or the transparent conductive layer 508 may be configured to apply the electric field across the modulator material layer 114. A transmissivity of light through the modulator material layer 114, and similarly through the electro-optic modulator 100, may change in accordance with a magnitude of the electric field applied across the modulator material layer 114 by the transparent conductive layer 504 and the transparent conductive layer 508. Intensity of light transmitted through the modulator material layer 114 may be modulated by variations in the electric field strength across the modulator material layer 114. Light transmission through the modulator material layer 114 may change in accordance with a magnitude of an electric field applied to the modulator material layer 114. The electric field may cause liquid crystals of the modulator material layer 114 to align in the direction of the electric field.

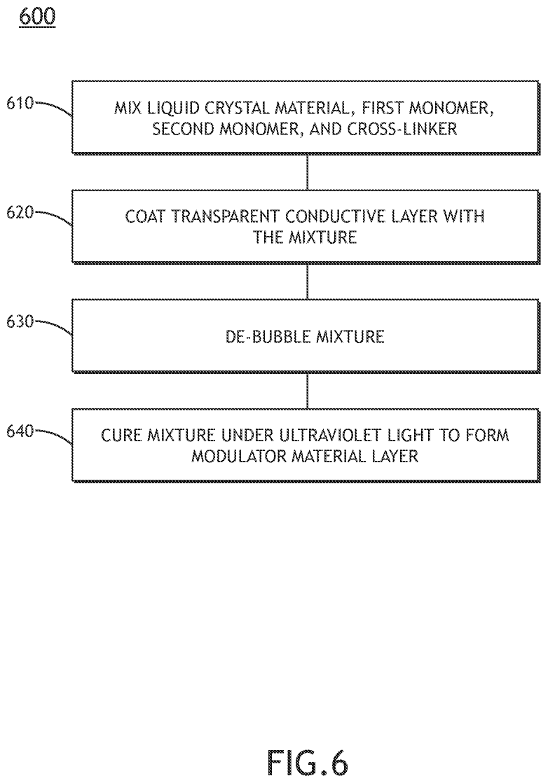

Referring now to FIG. 6, a flow diagram of a method 600 is described, in accordance with one or more embodiments of the present disclosure. The method may also be referred to as a process of manufacturing an electro-optic modulator. The embodiments and the enabling technologies described previously herein in the context of the electro-optic modulator 100, the modulator material layer 114 should be interpreted to extend to the method 600. It is further noted, however, that the method is not limited to the architecture of the electro-optic modulator 100 or the modulator material layer 114.

In a step 610, a liquid crystal material, first monomer, second monomer, cross-linker, photo-initiator, and/or additive may be mixed. The liquid crystal material, first monomer, second monomer, cross-linker, photo-initiator, and/or additive may be mixed in any manner, such as, but not limited to, using a mechanical force by a high-speed blade.

The liquid crystal material, first monomer, second monomer, cross-linker, photo-initiator, and/or additive may be mixed at a first elevated temperature. The first elevated temperature may be considered elevated in that the temperature may be elevated above room temperature. For example, the liquid crystal material, first monomer, second monomer, cross-linker, photo-initiator, and/or additive may be mixed at a first elevated temperature above room temperature up to 65 degrees Celsius. The first elevated temperature may be selected based on a formulation chemistry of the mixture.

The liquid crystal material may be soluble within the prepolymer materials (e.g., the first monomer, the second monomer, the cross-linker). For example, the liquid crystal material may interact with the (meth)acrylate groups of the first monomer, the second monomer, and the cross-linker. The mixture of the liquid crystal material, the first monomer, and the second monomer may be clear and/or homogenous. The mixture may not be phase-separated. For example, the liquid crystal material have not yet formed into the liquid crystal droplets 202. The solubility of the liquid crystal material within the prepolymer materials may be desirable for reducing a size of the liquid crystal droplets 202 after phase separation. The concentration of the second monomer may control the solubility of the liquid crystal material within the prepolymer materials. For example, increasing the concentration of the second monomer may increase the solubility of the liquid crystal material within the prepolymer materials.

The liquid crystal material, first monomer, second monomer, cross-linker, photo-initiator, and/or additive may be mixed while under yellow light, to prevent polymerization during mixing.

During mixing, one or more of the additives (e.g., wetting agents), may be added to the mixture. The additives may improve a solubility of the liquid crystal material within the mixture. The additives may be added to the mixture to improve wettability with a transparent conductive substrate.

In a step 620, a transparent conductive layer may be coated with the mixture. The coating may be by a bar, blade, spin, press, capillary filling, injection, ink jet printing, smearing, dispensing, and the like. For example, the transparent conductive layer 110 may be coated with the mixture. By way of another example, a capillary disposed between the transparent conductive layer 504 and the transparent conductive layer 508 may be coated with the mixture.

The mixture may be between room temperature and the first elevated temperature when coating the transparent conductive layer. The mixture may be between room temperature and the first elevated temperature to improve uniformity, remove bubbles, and/or fasten the mixture to the transparent conductive layer. For example, the mixture may be allowed to cool to room temperature before coating the transparent conductive layer with the mixture.

In a step 630, the mixture may be de-bubbled. The mixture may be de-bubbled by annealing and/or by vacuuming.

The mixture may be annealed at second elevated temperature to de-bubble the mixture. The first elevated temperature and the second elevated temperature may or may not be the same. For example, the transparent conductive film with the mixture may be annealed at a second elevated temperature between room temperature and 65 degrees Celsius. The annealing may partially set the polymer matrix 204.

A vacuum may be used to de-bubble the mixture and fasten the mixture to the transparent conductive layer. Although the mixture is described as annealed, this is not intended as a limitation of the present disclosure. The mixture may be de-bubbled by vacuuming with or without the annealing. Similarly, the mixture may be de-bubbled by annealing with or without vacuuming.

In a step 640, the mixture may be cured under ultraviolet light to form a modulator material layer. For example, the mixture may be cured to form the modulator material layer 114. The liquid crystal material may form the liquid crystal droplets 202 that are dispersed within the polymer matrix 204 during curing. The liquid crystal material may phase-separate from the monomers to form the liquid crystal droplets 202 dispersed within the polymer matrix 204. For example, the liquid crystal material may experience nanometer- or micrometer-scale phase separating into the liquid crystal droplets 202 during curing of the polymer matrix 204. The phase separation may cause the modulator material layer 114 to turn hazy due to random alignment of the liquid crystal materials within the liquid crystal droplets 202 when no electric field is applied. The random alignment of the liquid crystal materials within the liquid crystal droplets 202 may correspond to the anchoring between the aromatic rings of the liquid crystal material, the conjugated system end group of R2′ of the second polymer, and optionally the aromatic rings of R2″ of the cross-linker. The modulator material layer 114 may include the polymer matrix 204 and the liquid crystal droplets 202. The liquid crystal droplets 202 may be made of the liquid crystal material. The polymer matrix 204 may be the co-polymer which is polymerized from the first monomer, the second monomer, the cross-linker, the photo-initiator, and/or the additive.

The polymer matrix 204 may be photo-cured using ultra-violet (UV) light or the like. The photo-initiator may initiate polymerization of the first monomers, second monomers, and cross-linkers to the polymer matrix 204 upon exposure to the UV light. The cure time may include from 2 seconds to 20 minutes of exposure to UV light. The curing parameters of the UV light may include a wavelength from 365 to 405 nm (e.g., 385 nm), an energy flux (Isource) from 1 to 1000 mW/cm2 (e.g., 150 mW/cm2), with a spot size diameter (DUV spot) from 5 mm to 200 mm.

Referring generally again to the figures. It is contemplated that the electro-optic modulator 100 may provide several benefits for NCAP based EO modulators. The electro-optic modulator 100 may improve signal-to-noise ratio (SNR), dynamic range, and defectivity sensitivity as well as lower threshold fields of modulator product to detect defects during flat panel manufacturing. The electro-optic modulator 100 may include improved defect detection sensitivity and reduced threshold fields required for defect metrology during fabrication of flat-panel displays.

The electro-optic modulator 100 may include one or more alignment layers (not depicted). The alignment layers may also be referred to as passivation layers. For example, the electro-optic modulator 100 may include an alignment layer disposed between the transparent conductive layer 110 and the modulator material layer 114. By way of another example, the electro-optic modulator 100 may include an alignment layer disposed between the modulator material layer 114 and the dielectric mirror film 118. The alignment layers may improve the durability, surface wetting properties, and adhesion with the modulator material layer 114. The alignment layers may be a dielectric. The alignment layers may electrically insulate the modulator material layer 114 from the transparent conductive layer 110 and/or the dielectric mirror film 118. The alignment layers may include any dielectric material, such as, but not limited to, silicon dioxide (SiO2), polyethylene terephthalate (PET), polyimide (PI), or the like. It is contemplated that the alignment layers may or may not be needed by the electro-optic modulator 100. For example, the polymer chemistry of the modulator material layer 114 may be sufficiently improved such that the modulator material layer 114 to the transparent conductive layer 110 and/or the dielectric mirror film 118 without the alignment layers.

As used throughout the present disclosure, the term “sample” generally refers to a substrate formed of a semiconductor or non-semiconductor material (e.g., thin filmed glass, or the like). For example, a semiconductor or non-semiconductor material may include, but is not limited to, monocrystalline silicon, gallium arsenide, indium phosphide, or a glass material. A sample may include one or more layers. For example, such layers may include, but are not limited to, a resist (including a photoresist), a dielectric material, a conductive material, and a semiconductive material. Many different types of such layers are known in the art, and the term sample as used herein is intended to encompass a sample on which all types of such layers may be formed. One or more layers formed on a sample may be patterned or un-patterned. For example, a sample may include a plurality of dies, each having repeatable patterned features. Formation and processing of such layers of material may ultimately result in completed devices. Many different types of devices may be formed on a sample, and the term sample as used herein is intended to encompass a sample on which any type of device known in the art is being fabricated. Further, for the purposes of the present disclosure, the term sample and wafer should be interpreted as interchangeable. In addition, for the purposes of the present disclosure, the terms patterning device, mask and reticle should be interpreted as interchangeable.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A modulator material layer comprising:
a polymer matrix, wherein the polymer matrix comprises a co-polymer which is polymerized from a first monomer, a second monomer, and a cross-linker; and
a plurality of liquid crystal droplets dispersed within the polymer matrix.

2. The modulator material layer of claim 1, wherein the plurality of liquid crystal droplets range in size from 0.01 to 10 micrometers, wherein the plurality of liquid crystal droplets include an average size from 0.1 to 1.5 micrometers.

3. The modulator material layer of claim 2, wherein the plurality of liquid crystal droplets include the average size from 0.3 to 1 micrometers.

4. The modulator material layer of claim 1, wherein the plurality of liquid crystal droplets are from 50 wt. % to 80 wt. % of the modulator material layer.

5. The modulator material layer of claim 4, wherein the plurality of liquid crystal droplets are from 60 wt. % to 75 wt. % of the modulator material layer.

6. The modulator material layer of claim 1, wherein the first monomer comprises a (meth)acrylate group and R2 bonded to the (meth)acrylate group, wherein R2 comprises at least one of an alkane end group or a cycloalkane end group, wherein R2 does not comprise a conjugated system end group.

7. The modulator material layer of claim 6, wherein the first monomer comprises at least one of lauryl acrylate or isobornyl acrylate.

8. The modulator material layer of claim 1, the first monomer is from 5 wt. % to 13 wt. % of the modulator material layer.

9. The modulator material layer of claim 8, the first monomer is from 6 wt. % to 10 wt. % of the modulator material layer.

10. The modulator material layer of claim 1, wherein the second monomer comprises a (meth)acrylate group and R2′ bonded to the (meth)acrylate group, wherein R2′ comprises a conjugated system end group.

11. The modulator material layer of claim 10, wherein the conjugated system end group comprises an aryl group.

12. The modulator material layer of claim 11, wherein the aryl group comprises at least one of a phenyl group or a naphthyl group.

13. The modulator material layer of claim 12, wherein the second monomer comprises at least one of ethylene glycol phenyl ether acrylate, 2-Naphthyl acrylate, or Pentafluorophenyl acrylate.

14. The modulator material layer of claim 1, the second monomer is from 7 wt. % to 15 wt. % of the modulator material layer.

15. The modulator material layer of claim 14, the second monomer is from 13 wt. % to 15 wt. % of the modulator material layer.

16. The modulator material layer of claim 1, wherein the cross-linker is a multi-(meth)acrylate monomer with two, three, or four (meth)acrylate groups.

17. The modulator material layer of claim 16, wherein the cross-linker comprises at least one of 1,6-Hexanediol diacrylate, 1,4-Phenylene dimethacrylate, Bisphenol A dimethacrylate, 1,4-Bis[4-(3-acryloyloxypropoxy)benzoyloxy]-2-methylbenzene, or 2-Methyl-1,4-phenylene Bis[4-[[[4-(acryloyloxy)-butoxy]carbonyl]oxy]benzoate].

18. The modulator material layer of claim 1, the cross-linker is from 1 wt. % to 10 wt. % of the modulator material layer.

19. The modulator material layer of claim 18, the cross-linker is from 6 wt. % to 8 wt. % of the modulator material layer.

20. The modulator material layer of claim 1, wherein the first monomer is lauryl acrylate, wherein the second monomer is ethylene glycol phenyl ether acrylate, wherein the cross-linker is 1,6-Hexanediol diacrylate.

21. The modulator material layer of claim 1, wherein the polymer matrix comprises a photo-initiator, wherein the photo-initiator is from 0 wt. % to 3 wt. % of the modulator material layer.

22. The modulator material layer of claim 1, wherein the modulator material layer is a nematic curvilinear aligned phase (NCAP) film.

23. The modulator material layer of claim 1, wherein the plurality of liquid crystal droplets are randomly oriented while no electric field is present, wherein the plurality of liquid crystal droplets at least partially align along a direction of an electric field while the electric field is applied across the modulator material layer.

24. The modulator material layer of claim 1, comprising an additive, wherein the additive is an interface between the plurality of liquid crystal droplets and the polymer matrix.

25. An electro-optic modulator comprising:
a transparent conductive layer;
a modulator material layer, wherein the transparent conductive layer is configured to apply an electric field across the modulator material layer, the modulator material layer comprising:
a polymer matrix, wherein the polymer matrix comprises a co-polymer which is polymerized from a first monomer, a second monomer, and a cross-linker; and
a plurality of liquid crystal droplets dispersed within the polymer matrix; and
a dielectric mirror film, wherein the modulator material layer is disposed between the transparent conductive layer and the dielectric mirror film.

26. The electro-optic modulator of claim 25, comprising a dielectric substrate, wherein the dielectric mirror film is disposed between the modulator material layer and the dielectric mirror film.

27. An imaging system comprising:
an illumination source configured to generate illumination;
a stage for a sample;
a detector to generate an image of at least a portion of the sample; and
an electro-optic modulator disposed in a path of the illumination from the illumination source and separated from the sample by an air gap, wherein the electro-optic modulator comprises:
a transparent conductive layer, wherein the transparent conductive layer is configured to generate an electric field by capacitively coupling to the sample;
a modulator material layer, wherein the transparent conductive layer is configured to apply the electric field across the modulator material layer, the modulator material layer comprising:
a polymer matrix, wherein the polymer matrix comprises a co-polymer which is polymerized from a first monomer, a second monomer, and a cross-linker; and
a plurality of liquid crystal droplets dispersed within the polymer matrix; and
a dielectric mirror film, wherein the modulator material layer is disposed between the transparent conductive layer and the dielectric mirror film.

28. A test cell comprising:
a first glass substrate;
a first transparent conductive layer coated on the first glass substrate;
a second glass substrate;
a second transparent conductive layer coated on the second glass substrate, wherein the first transparent conductive layer and the second transparent conductive layer are disposed between the first glass substrate and the second glass substrate, wherein the first transparent conductive layer and the second transparent conductive layer are configured to generate an electric field; and
a modulator material layer, wherein the modulator material layer is disposed between the first transparent conductive layer and the second transparent conductive layer, wherein the first transparent conductive layer and the second transparent conductive layer are configured to apply the electric field across the modulator material layer, the modulator material layer comprising:
a polymer matrix, wherein the polymer matrix comprises a co-polymer which is polymerized from a first monomer, a second monomer, and a cross-linker; and
a plurality of liquid crystal droplets dispersed within the polymer matrix.

29. A method comprising:
mixing a liquid crystal material, a first monomer, a second monomer, and a cross-linker to form a mixture;
coating a transparent conductive layer with the mixture;
de-bubbling the mixture; and
curing the mixture under ultraviolet light to form a modulator material layer comprising:
a polymer matrix, wherein the polymer matrix comprises a co-polymer which is polymerized from the first monomer, the second monomer, and the cross-linker; and
a plurality of liquid crystal droplets dispersed within the polymer matrix, wherein the plurality of liquid crystal droplets are made of the liquid crystal material.
